(19) United States
(12) Patent Application Publication
(10) Pub. No.: US 2025/0326287 A1
(43) Pub. Date: Oct. 23, 2025

(54) MULTI-MOTOR ELECTRIC DRIVE UNIT

(71) Applicant: Dana Automotive Systems Group, LLC, Maumee, OH (US)

(72) Inventors: Steven VANHEE, Hooglede (BE); Joachim DRUANT, Houthulst (BE); Maarten DEBROUWERE, Zedelgem (BE); Frederik DESMET, Maldegem (BE)

(21) Appl. No.: 18/638,279

(22) Filed: Apr. 17, 2024

(51) Int. Cl. B60K 7/00; B60K 11/02; B60K 17/02; B60K 17/04; B60L 15/00; B60L 15/20; F16H 61/04; H02K 7/108; H02K 7/116; H02K 9/19; H02K 11/33

(52) U.S. Cl. CPC B60K 7/0007; B60K 11/02; B60K 17/02; B60K 17/046; B60L 15/007; B60L 15/2054; F16H 61/0403; H02K 7/108; H02K 7/116; H02K 9/19; H02K 11/33; B60K 2007/003; B60K 2007/0053; B60K 2007/0061; F16H 2061/0422; F16H 2061/0488

(57) ABSTRACT

Methods and systems for an electric drive unit. The electric drive unit includes, in one example, a stator assembly with a first set of stator windings and a second set of stator windings, a first set of rotors in which each rotor is configured to electromagnetically interact with the first set of stator windings and rotationally couple to a distinct gear in a first summation gear set, a second set of rotors in which each rotor is configured to electromagnetically interact with the second set of stator windings and rotationally couple to a distinct gear in a second summation gear set. The electric drive unit further includes a disconnect clutch configured to rotationally disconnect a first rotor in the first set of rotors from the first summation gear set.

### TECHNICAL FIELD

The present description relates generally to an electric drive unit with multiple sets of electric motors that drive summation gear sets.

### BACKGROUND AND SUMMARY

Electric drives have been utilized in certain vehicles as the transportation sector moves toward powertrain electrification. Some electric drives use gear sets such as planetary gear sets which are driven by a single comparatively large traction motor. Other electric drives have made use of two comparatively large diameter and short axial length electric motors. These electric drives can experience undesirable stator losses during vehicle cruising, for example. Further, certain twin motor electric axles architectures exhibit unused volume in the center of the motors, impacting electric axle compactness.

U.S. Pat. No. 9,487,084 B2 to Petersen et al. shows an electric drive with multiple motors which provide parallel input to a Ravigneaux gear set. The Ravigneaux gear set includes sun gears which are coupled to differential planet gears.

The inventors have recognized several issues with Petersen's multi-motor electric drive. For instance, Petersen's Ravigneaux gear set is complex and may be difficult to manufacture. Further, Petersen is silent with regard to any sort of system used for electrical power delivery to the motors. Further, the inventors have recognized that other electric drive systems which have made use of two motors and inverters present manufacturing and cost challenges when compared to electric drive systems which solely use one motor and one inverter in the electric drive.

The inventors have recognized the aforementioned challenges and developed an electric drive unit to at least partially overcome the challenges. The electric drive unit includes, in one example, a stator assembly that includes a first set of stator windings, a second set of stator windings, and a first set of rotors in which each rotor is configured to electromagnetically interact with the first set of stator windings and rotationally couple to a distinct gear in a first summation gear set. The electric drive unit even further includes a second set of rotors in which each rotor is configured to electromagnetically interact with the second set of stator windings and rotationally couple to a distinct gear in a second summation gear set. The electric drive unit even further includes a first disconnect clutch configured to rotationally disconnect a rotor in the first set of rotors from the first summation gear set and a second disconnect clutch configured to rotationally disconnect a rotor in the second set of rotors from the second summation gear set. In this way, the electric drive unit can disconnect one or more motors which allows the drive unit to be more efficiently operated during partial load conditions.

Further, in one example, the electric drive unit includes a controller configured to disengage the first disconnect clutch and the second disconnect clutch during a partial load condition. In this way, electric drive unit operating efficiency may be further increased.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 is an illustration of an electric vehicle (EV) with a first example of an electric drive unit.

FIGS. 2A-2C are different cross-sectional views of the electric drive unit, depicted in FIG. 1.

FIG. 3 is an illustration of a second example of an electric drive unit that includes a disconnect unit.

FIG. 4 is an illustration of a third example of an electric drive unit with a cooling system that includes a pump motor and a coolant pump.

FIGS. 5A-5B are detailed side views of the electric drive unit, depicted in FIG. 4.

FIG. 6 is an illustration of a method for operation of an electric drive unit.

FIG. 7 is an example electric drive unit operating sequence during a partial load condition.

FIGS. 8-10 are cross-sectional views of the electric drive unit, depicted in FIG. 4.

FIG. 11 shows an example of an inverter assembly for an electric drive unit.

### DETAILED DESCRIPTION

Electric drive units and systems are described herein which achieve operating efficiency gains due to a reduction in stator iron losses, and increased space efficiency specifically with regard to the drive unit width. These stator iron loss reductions may be particularly prominent during vehicle coasting and in electric drive units which use permanent magnet motors, although the electric drive units described herein may use a wide variety of electric motor types. These operating efficiency gains and increases in drive unit compactness are achieved by designing the electric drive units with electric drives for opposing drive wheels. Both of the electric drive use multiple traction motors that are directly rotationally coupled to distinct gears, such as planet gears, in summation gear sets. Gear reductions (e.g., final gear reductions) may be used to connect the summation gear sets to the drive wheels. Further, in one example, the electric drive units may include a cooling system with a pump motor and coolant pump positioned circumferentially inward from the traction motors. In this way, the cooling system is space efficiently incorporated into the drive units. Consequently, drive unit operating and space efficiency is increased.

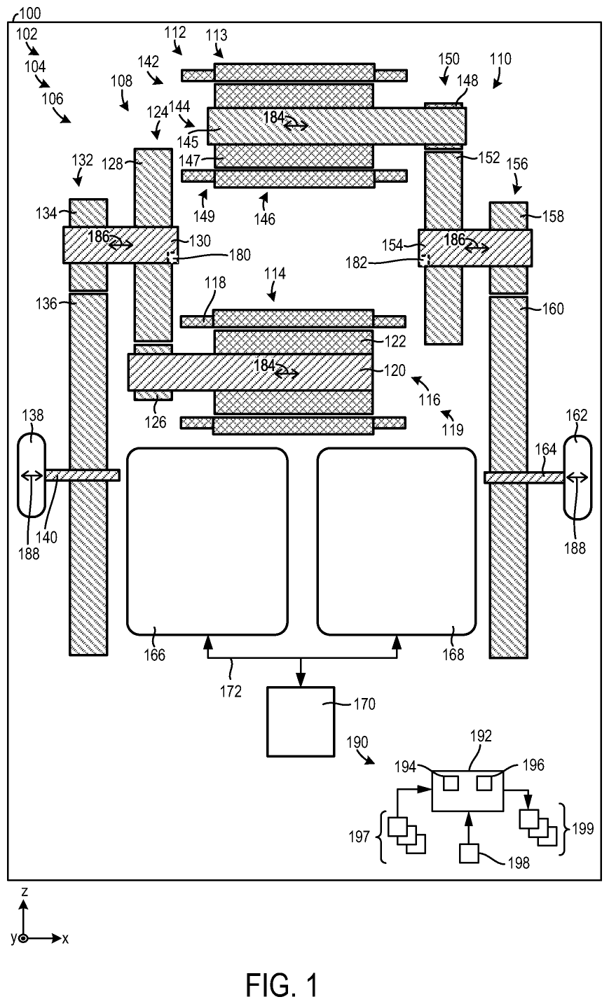

FIG. 1 shows an electric vehicle (EV) 100 with a powertrain 102 that includes an electric drive system 104 with an electric drive unit 106 (e.g., an electric axle). It will be understood that an electric axle is a powertrain where the traction motors as the transmission as well as the inverters, in some cases, are packaged into an axle assembly such that the components are collocated. The EV 100 may be an all-electric vehicle (e.g., battery electric vehicle (BEV)), in one example, or a hybrid electric vehicle, in another example. As such, vehicles that utilize the electric drive units described herein may also have an internal combustion engine (e.g., a spark ignition engine, a compression ignition engine, combinations thereof, and the like), in some examples. Thus, the electric drive units described herein may be used in cars, trucks, ATVs, commercial vehicles, light vehicles, off-highway vehicle, mining vehicles, and the like.

In the illustrated example, the electric drive unit 106 includes independent drives for the drive wheels (which are the left and right drive wheels in the frame of reference depicted in FIG. 1). To elaborate, the electric drive unit 106 includes electric drives 108 and 110. Put another way, the electric drive unit 106 includes motor and gearbox assemblies for each of the drive wheels which may be operated independently.

A stator assembly 112 is provided in the electric drive unit 106. The stator assembly 112 may be included in both of the electric drives 108 and 110. The stator assembly 112 may include a lamination stack 113 and multiple sets of stator windings which induce rotation of a corresponding rotor via electromagnetic interaction. Specifically, a first set of stator windings 114 are included in the stator assembly 112 and associated with the electric drive 108 in the illustrated example. The first set of stator windings 114 circumferentially surround a rotor. The electric drive unit 106 may also conceptually include a first set of rotors 116 that are associated with the first set of stator windings 114. A first set of end windings 118 may correspond to the first set of stator windings 114. The first set of stator windings 114 and the first set of rotors 116 are included in the electric drive 108. The first set of stator windings 114, the first set of rotors 116, and the first set of end windings 118 form a first set of electric motors 119 in the electric drive 108. Each of the laminations stacks in the stators described herein include end windings. Therefore, the end windings may be referred to as sets or groups of end windings. In one specific example, the first and second sets of rotors may each include three rotors and the stator assembly may include end windings associated with each of these rotors. In such an example, the equivalent diameter of the individual motors may be equal to ⅓ of the overall stator stack assembly diameter. However, other drive unit architecture with a fewer or greater number of rotors and associated stator winding assemblies are possible.

The rotors in the first set of rotors 116 each include a shaft 120 and a rotor body 122. Traction motors described herein may take a variety of forms. For instance, more generally, the traction motors described herein may be, but are not limited to, multi-phase (e.g., three-phase, four-phase, six-phase, etc.) alternating current (AC) motors. Further, the electric motors described herein may be permanent magnet motors which include permanent magnets in the rotors. However, a variety of motors may be used in other examples. Further, the electric motors described herein may be configured to operate in a drive mode as well as a regeneration mode, in some cases. In the regeneration mode, the machine generates electrical energy. In other examples, the traction motors described herein may be induction motors, also referred to as asynchronous motors. However, in other examples, alternate types of traction motors may be used in the electric drive unit 106.

The rotors in the first set of rotors 116 are each coupled to a distinct gear in a first summation gear set 124 that is included in the electric drive 108. To elaborate, the rotor shaft in the first set of rotors 116 are each coupled to a planet gear 126 in the first summation gear set 124, in the illustrated embodiment.

Although solely a single rotor and a single planet gear in the electric drive 108 are visible in the frame of reference, depicted in FIG. 1, it will be appreciated that the first summation gear set 124 includes additional planet gears. For instance, the first summation gear set 124 may include three planet gears, in one example. In other examples, the first summation gear set 124 may include two planet gears or more than three planet gears, for instance.

The planet gears 126 mesh with a sun gear 128. Additionally, a layshaft 130 rotationally couples the sun gear 128 to a gear reduction 132 (e.g., a first final gear reduction). It will be understood that the layshaft 130 and the gear reduction 132 are included in the electric drive 108. The gear reduction 132 includes a gear 134 that is fixedly coupled to the layshaft 130 such that it rotates therewith and a gear 136 which meshes with the gear 134. In turn, the gear 136 is rotationally coupled to (e.g., directly rotationally coupled to) a drive wheel 138 via a drive shaft 140.

The electric drive 110 includes a second set of electric motors 142 with a second set of rotors 144, a second set of stator windings 146, and a second set of end windings 149. The second set of stator windings 146 include individual stacks which surround each of the rotors in the second set of rotors 144 and electromagnetically interact therewith. The second set of stator windings 146 are included in the stator assembly 112. Further, each of the rotors in the second set of rotors 144 include a rotor shaft 145 and a rotor body 147.

The second set of rotors 144 are each rotationally coupled to a planet gear 148 in a second summation gear set 150. Further, the planet gears 148 mesh with a sun gear 152 which is fixedly rotationally coupled to a layshaft 154. A gear reduction 156 (e.g., a final gear reduction) is further included in the electric drive 110 of the electric drive unit 106. The gear reduction 156 includes a gear 158 that is fixedly coupled to the layshaft 154 such that it rotates therewith and a gear 160 which meshes with the gear 158. In turn, the gear 160 is rotationally coupled to (e.g., directly rotationally coupled to) a drive wheel 162 via a shaft 164.

In the illustrated example, a first inverter 166 and a second inverter 168 are electrically coupled to the first set of electric motors 119 and the second set of electric motors 142. The inverters 166 and 168 convert DC power to AC power and vice versa. However, in alternate examples, one inverter may be used to electrically power both electric machines or the inverters may be omitted if DC electric machines are utilized in the powertrain.

The inverters 166 and 168 may receive electric energy from the one or more energy storage device(s) 170 (e.g., traction batteries, capacitors, fuel cells, combinations thereof, and the like). Arrows 172 signify the electric energy transfer between the inverters 166 and 168 and the energy storage device(s) 170 that may occur during different modes of system operation. It will be understood that electrically energy is also transferred from the inverters to motors in the electric drive. In one example, the inverters 166 and 168 may each be electrically coupled to the one or more energy storage device(s) 170. However, in other examples, the inverters 166 and 168 may be electrically coupled to different energy storage devices. The other inverters described herein may be electrically coupled to similar energy storage device(s). Therefore, redundant description of the energy storage devices is omitted for concision.

As shown in FIG. 1, the EV 100 may further include a control system 190 with a controller 192. The controller 192 may include a microcomputer with components such as a processor 194 (e.g., a microprocessor unit), input/output ports, an electronic storage medium 196 for executable programs and calibration values, e.g., a read-only memory chip, random access memory, keep alive memory, a data bus, and the like. The storage medium may be programmed with computer readable data representing instructions which are executable by a processor for performing the methods, control techniques, and the like described herein as well as other variants that are anticipated but not specifically listed. Therefore, the electronic storage medium 196 may hold instructions stored therein that when executed by the processor 194 cause the controller 192 to perform the various method steps described herein.

The controller 192 may receive various signals from sensors 197 coupled to different regions of the EV 100 and specifically the electric drive unit 106. For example, the sensors 197 may include one or more motor speed sensors which may be in the form of resolvers that are elaborated upon below, one or more electric motor load sensors, shaft/gear speed sensors, a pedal position sensor to detect a depression of an operator-actuated pedal (e.g., an accelerator pedal and/or a brake pedal), speed sensors at the vehicle wheels, and the like. An input device 198 (e.g., accelerator pedal, brake pedal, gear selector, combinations thereof, and the like) may further provide input signals indicative of an operator's intent for vehicle control.

Upon receiving the signals from the various sensors 197 of FIG. 1, the controller 192 processes the received signals, and employs various actuators 199 of vehicle components to adjust the components based on the received signals and instructions stored on the memory of controller 192. For example, the controller 192 may receive an accelerator pedal signal indicative of an operator request for a vehicle acceleration adjustment. In response, the controller 192 may command operation of the inverters 166 and 168 which are electrically coupled to the sets of electric motors 119 and 142 to increase the power delivered from the motors to the summation gear sets 124 and 150. The other controllable components in the vehicle may function in a similar manner with regard to sensor signals, control commands, and actuator adjustment, for example. Further, the control system 190 may be used in any of the electric drive systems and units described herein.

A first resolver 180 coupled to the layshaft 130 may be used in the electric drive 108 to determine the speed of the first set of electric motors 119. Likewise, a second resolver 182 coupled to the layshaft 154 may be used in the electric drive 110 to determine the speed of the second set of electric motors 142.

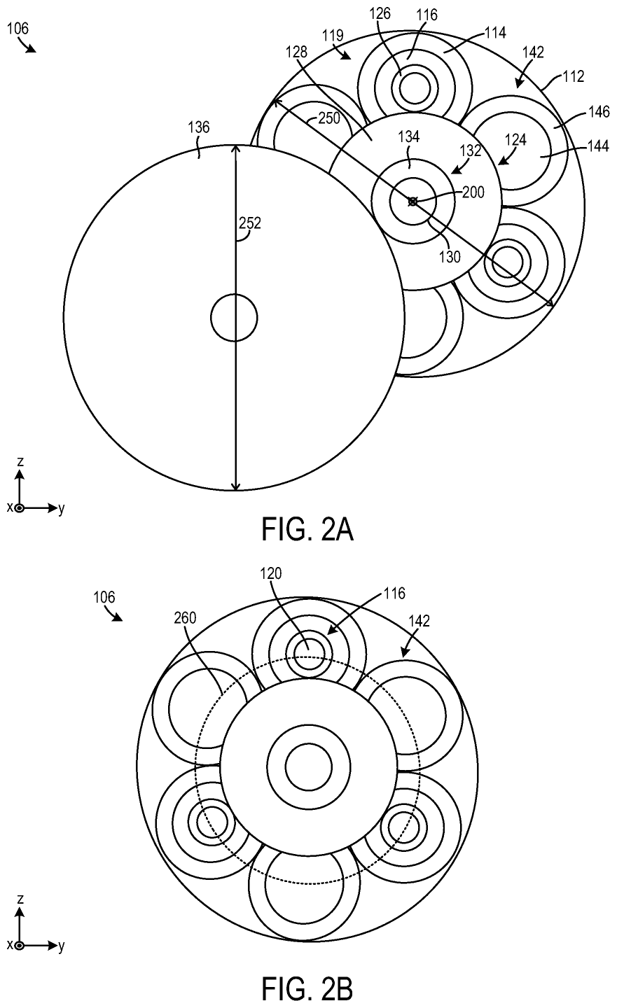

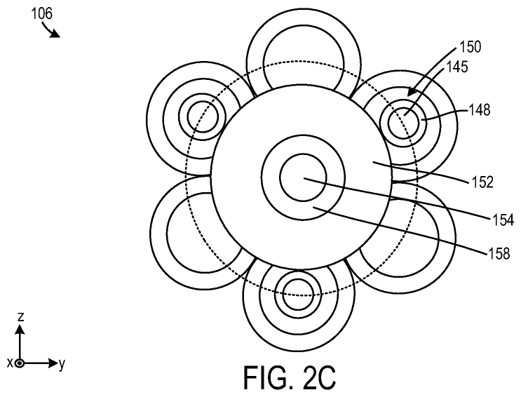

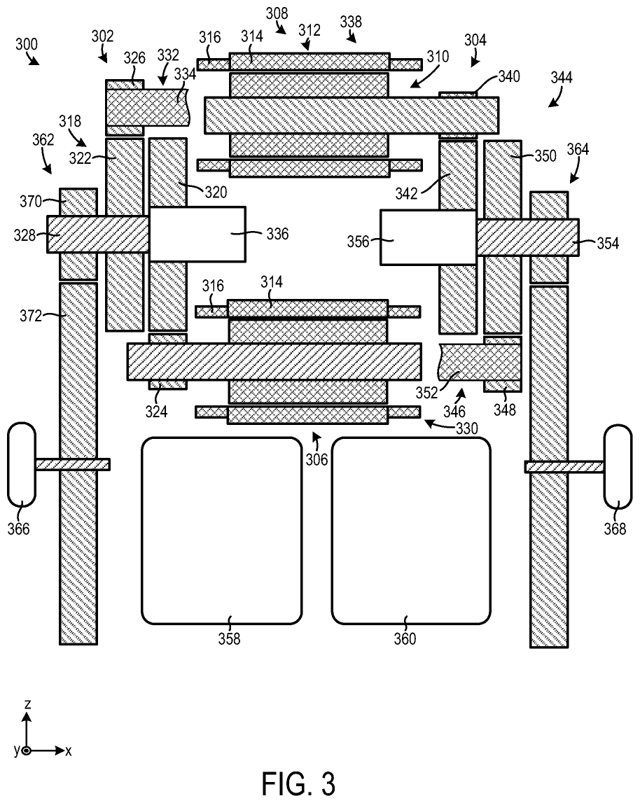

An axis system is provided in FIG. 1, as well as FIGS. 2A-5B and 8-11, for reference. The z-axis may be a vertical axis (e.g., parallel to a gravitational axis), the x-axis may be a lateral axis (e.g., horizontal axis), and the y-axis may be a longitudinal axis, in one example. However, in other examples, the axes may have other orientations. Rotational axes 184 of electric motors in the first and second sets of electric motors 119 and 142 are provided in FIG. 1. Additionally, rotational axes 186 of the layshafts 130 and 154 are further depicted in FIG. 1. Still further, rotational axes 188 of the drive wheels 138 and 162 are further depicted in FIG. 1. The cross-sectional views depicted in FIG. 1 as well as FIGS. 3-4 are in the z-x plane and extends through the aforementioned rotational axes.

Due to the smaller size of the rotors in comparison to electric drives with fewer number of motors, the electric motors in the electric drive unit 106 may be operated at a speed >25,000 revolution per minute (RPM), if desired. Further, the gear ratios of each of the left and right electric drives 108 and 110 may be 1:16, in one specific example. To elaborate, in such an example, the gear ratio of the summation gear set and the subsequent gear reduction for each of the left and right electric drives may be 4:1. In this way, the electric drive unit 106 is able to achieve target drive wheel speeds. For instance, the drive wheel speeds may be around 1,800 RPM during certain conditions. However, the electric drive unit may have other suitable ratios for the left and right drives, in alternate examples. The gear ratio may be selected based on the type of electric motors used in the drive unit, the expected operating speed of the motors, the efficiency curves of the motors, the end use powertrain performance goals, and the like.

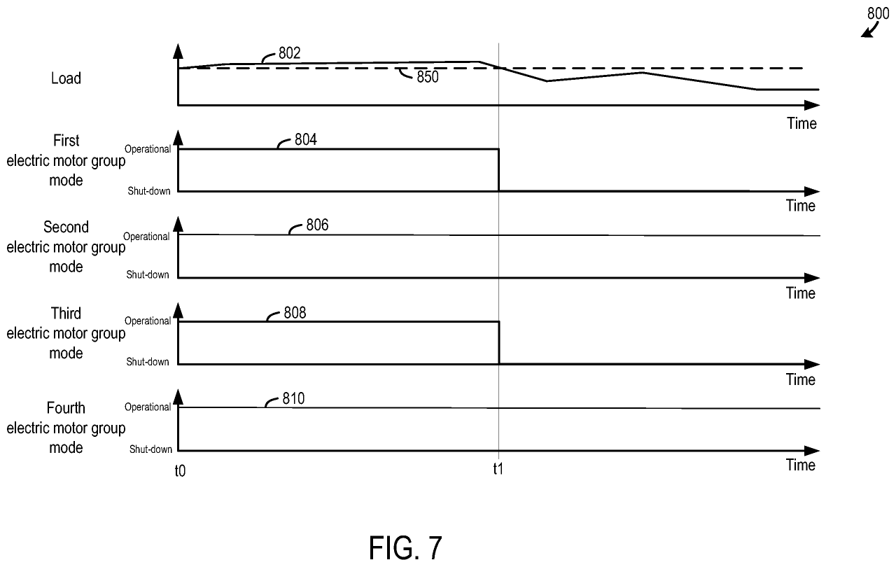

Further in one example, the electric drive unit 106 may further include a cooling system which is configured to provide direct lamination cooling and immersion end winding cooling. Further, one baffle could be developed to perform the hydraulic routing of the oil. An example of a drive unit cooling system is shown in FIG. 4 as well as FIGS. 8-10 and discussed in greater detail herein.

FIG. 2A shows a cross-sectional view of the electric drive unit 106 with the stator assembly 112 in the z-y plane. The first set of electric motors 119 with the first set of rotors 116 and the first set of stator windings 114 are depicted. Similarly, the second set of electric motors 142 with the second set of rotors 144 and the second set of stator windings 146 are depicted.

The first set of electric motors 119 and the second set of electric motors 142 are circumferentially arranged. To elaborate, the motors in the first set of electric motors 119 may be spaced 120° with regard to a central axis 200. Similarly, the motors in the second set of electric motors 142 may be spaced 120° with regard to the central axis 200. Further, motors in the first set of electric motors 119 are positioned between motors in the second set of electric motors 142. Thus, adjacent motors in the first and second sets of electric motors may be spaced 60° apart with regard to the central axis. However, the motors may have another suitable arrangement in other embodiments.

The planet gears 126 and the sun gear 128 in the first summation gear set 124 are further shown in FIG. 2A. The layshaft 130 is further shown in FIG. 2A along with the gear reduction 132 which includes gears 134 and 136.

In the illustrated example, an outer diameter 250 of the stator assembly 112 is equivalent to an outer diameter 252 of the gear 136. In this way, a desired form factor of the electric drive unit may be achieved. However, the stator assembly 112 and the gear 136 may have other relative sizes, in other examples.

FIG. 2B shows the electric drive unit 106 with the gear reduction 136, depicted in FIG. 2A omitted to reveal underlying components. To elaborate, FIG. 2B shows the first set of rotors 116 where each of the rotors and specifically rotor shafts 120 are shown with a 120° spacing, in the illustrated example. However, a different number of rotors and therefore motors with a different spacing may be used in alternate examples. For instance, six motors may be used in each of the electric drive units, in another example.

The second set of electric motors 142 is further shown in FIG. 2A. As illustrated the first set of electric motors 119 and the second set of electric motors 142 are arranged around a circle 260 in the illustrated example to allow the motors to be compactly packed within the drive unit and provide pinion inputs into the summation gear sets for the left and right electric drives. Arranging the electric motors in for the left and right drive units in a circle allows the electric drive unit's compactness to be increased and specifically the lateral width of the drive unit to be reduced to allow the drive unit to be packaged in a wider variety of vehicle platforms. Further, using the planet gears as inputs for the summation gear sets enables for this space efficient motor arrangement and also allows the summation gear sets to achieve a desired gear ratio.

FIG. 2C shows a cross-sectional view of the electric drive unit 106 on the opposite side (in relation to the x-axis) to show the rotor shafts 145 of the second set of electric motors 142 which connect to the planet gears 148 in the second summation gear set 150. The sun gear 152 in the second summation gear set 150 is further depicted. As shown in FIG. 1, the sun gear 152 is fixedly coupled to the layshaft 154 which has the gear 158 fixedly coupled thereto. The gear 160 shown in FIG. 1 is omitted from FIG. 2C to reveal underlying components in the electric drive unit.

FIG. 3 shows another example of an electric drive unit 300. The electric drive unit 300 again includes a first electric drive 302 and a second electric drive 304 which allow power to be independently delivered to laterally opposing drive wheels from a first set of electric motors 306 and a second set of electric motors 308. Both the first and second sets of electric motors 306 and 308 again include rotors 310 which are circumferentially surrounded by stators 312 that include laminations 314 and end windings 316, similarly to the previously described electric motors. Redundant description is omitted for brevity.

The first set of electric motors 306 is coupled to a compound summation gear set 318 (e.g., a stepped summation gear set). To elaborate, the compound summation gear set 318 includes a first sun gear 320, a second sun gear 322, a first set of planet gears 324 that mesh with the first sun gear 320, and a second set of planet gears 326 that mesh with the second sun gear 322. Both sun gears 320 and 322 are coupled to a layshaft 328 such that they rotate therewith.

A portion of the motors 330 in the first set of electric motors 306 are rotationally coupled to planet gears 324 which mesh with the first sun gear 320 in the compound summation gear set 318. Another portion of the motors 332 in the first set of electric motors 306 are rotationally coupled to planet gears 326 which mesh with the second sun gear 322 in the compound summation gear set 318. Although, solely the rotor shafts 334 of the portions of the motors 332 in the first set of electric motors 306 are illustrated, it will be understood that the motors include stator end windings similar to the other motors described herein. Both the first sun gear 320 and the second sun gear 322 are arranged coaxial to the layshaft 328. Specifically, the second sun gear 322 may be fixedly coupled to the layshaft 328 and the first sun gear 320 may be selectively coupled to the layshaft 328 using a disconnect clutch 336. In one specific example, when the first set of electric motors 306 includes three motors, the group of the motors 330 may include two motors and the group of motors 332 may include one motor or vice versa. In on example, the double layshaft summation gear sets may have a V-configuration where the first sun gear 320 and the second sun gear 322 may be designed as helical gears and may have a symmetric design. In this way, the axial force on the bearing of the intermediate shaft may be reduced.

Similarly, a portion of the motors 338 in the second set of electric motors 308 are rotationally coupled planet gears 340 which mesh with a first sun gear 342 in a compound summation gear set 344 (e.g., stepped summation gear set). Another portion of the motors 346 in the second set of electric motors 308 are rotationally coupled to planet gears 348 which mesh with a second sun gear 350 in the compound summation gear set 344. Although, solely the rotor shafts 352 of the portions of the motors 346 in the second set of electric motors 308 are illustrated, it will be understood that the motors include stator end windings similar to the other motors described herein. In one specific example, when the second set of electric motors 308 includes three motors, the group of the motors 338 may include two motors and the group of motors 346 may include one motor or vice versa. Further, it will be appreciated that each of the left and right electric drives 304 and 306 may have an equivalent number of motors. The other electric drive unit may also have an equivalent number of motors in both electric drives.

Both the first sun gear 342 and the second sun gear 350 are arranged coaxial to a layshaft 354. Specifically, the second sun gear 350 may be fixedly coupled to the layshaft 354 and the first sun gear 342 may be selectively coupled to the layshaft using a disconnect clutch 356. The disconnect clutches 336 and 356 may be friction clutches or dog clutches, in different examples.

In the illustrated example, a first inverter 358 and a second inverter 360 are electrically coupled to the first set of electric motors 306 and the second set of electric motors 308. The inverters 358, 360 convert DC power to AC power and vice versa. The inverters 358 and 360 may include switches which allow the different groups of motors to be independently disconnected. For example, via an electromagnetic actuator or electric semiconductor switches or a relay system.

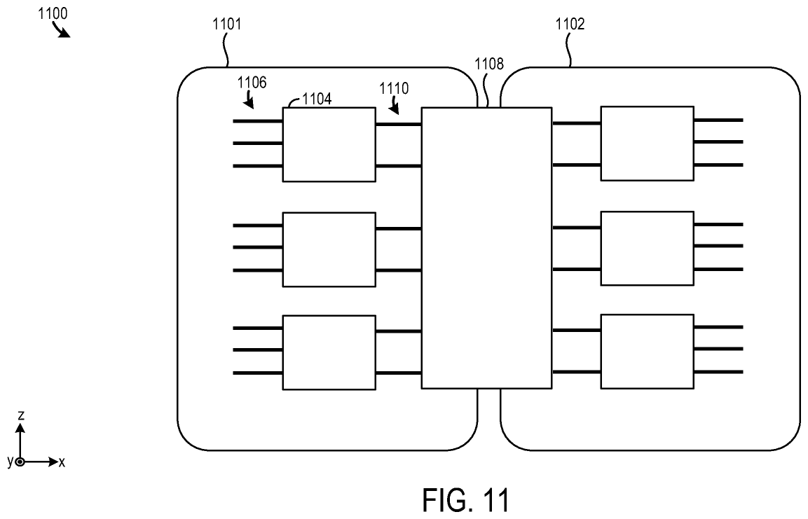

FIG. 11 shows an example of an inverter assembly 1100 with a first inverter 1101 and a second inverter 1102 which may be included in any of the electric drive units described herein. Each of the inverters 1101 and 1102 include a plurality of multi-phase (e.g., three-phase) power modules 1104 which include multi-phase electrical interfaces 1106. Further, each of the power modules 1104 may be electrically connected to a DC link capacitor 1108 which is shared between the first and second inverters via DC electrical connections 1110. Each power module controls the phases of a single motor. In the embodiment depicted in FIG. 11, the separate power modules can be used to synchronize each motor with the wheel speed, if desired.

In alternate examples, one inverter may be used to electrically power both electric machines. When a single inverter is utilized in the electric drive unit 300, a synchronizer may be included in each of the first electric drive 302 and the second electric drive 304 shown in FIG. 3. To elaborate, each synchronizer may be configured to lock the rotation of the disconnected rotor in the corresponding drive unit with the rotors which are in operation.

The electric drive unit 300 again includes gear reductions 362 and 364 (e.g., final gear reductions) for each of the electric drives 302 and 304 which allow the compound summation gear sets 318 and 344 to be rotationally coupled to drive wheels 366 and 368, respectively.

Each of the gear reductions 362 and 364 includes a gear 370 that is fixedly coupled to the associated layshaft such that it rotates therewith and a gear 372 which meshes with the gear 370 and is rotationally coupled (e.g., directly rotationally coupled) to the corresponding drive wheel.

FIG. 4 shows yet another example of an electric drive unit 400. The electric drive unit 400 includes a first set of electric motors 402, a first summation gear set 404, and a gear reduction 406 in a first electric drive 408. The electric drive unit 400 further includes a second set of electric motors 410, a second summation gear set 412, and a gear reduction 414 in a second electric drive 416. The electric motor and summation gear set structure and function in the electric drive unit 400 depicted in FIG. 4 is similar to the structure and function of the electric motor and the summation gear set in the electric drive unit 106 depicted in FIG. 1. Redundant description of the electric motor and summation gear set features is omitted for brevity.

A stator assembly 417 is included in the electric drive unit 400. The stator assembly 417 may include a lamination stack 419 and multiple sets of stator windings 423, similar to the other drive unit embodiments described herein.

The electric drive unit 400 includes a cooling system 418 with a pump motor 420 positioned radial inward from the first set of electric motors 402 and the second set of electric motors 410 which are arranged in a circle in the illustrated example. The pump motor 420 includes stator windings 421 and a rotor 425, which may have a similar construction to the other electric motors described herein. The stator windings 421 may be included in the stator assembly 417. In this way, the pump motor is space efficiently incorporated into the drive unit.

The pump motor 420 is rotationally coupled to a coolant pump 422 (e.g., an oil pump) which may be arranged coaxial to the electric pump. The coolant pump 422 is also positioned radially inward from the first and second sets of motors 402 and 410. In this way, the compactness of the electric drive unit is increased while providing drive unit cooling functionality.

The coolant pump 422 includes an outlet 424 with radial channels 427 which direct the coolant (e.g., oil) to an oil distribution plate 429. To elaborate, the stator lamination stack may be split into two sub-stacks. In such an example, the oil distribution plate may be positioned between the two sub-stacks. Arrows 431 generally denote the direction of coolant flow through the stator end windings and into enclosures 426 around the end windings 428. Specifically, one or more axial coolant channels may extend through each set of stator end windings. To elaborate, coolant may be directed in opposing axial directions through the stator end windings, in one example. However, in other examples, coolant may be directed solely in one axial direction through the stator end windings. Although coolant flow is denoted with arrows, it will be appreciated that in practice the coolant flow may have greater complexity. The enclosures 426 may be specifically configured to provide immersion cooling to the end windings. Consequently, electric drive unit operating efficiency is increased. Further, in the illustrated embodiment, ports 430 in each of the enclosures 426 are in fluidic communication with an inlet 432 of the coolant pump. To elaborate, the inlet 432 may be in fluidic communication with a drive unit sump 433 which receives coolant from the enclosures 426.

The cooling system 418 is further configured to direct coolant to enclosures 426 around the end windings 428 of each of the stators in both the first set of electric motors 402 and the second set of electric motors 410. In one example, oil baffles in the cooling system 418 may be used to collect oil and guide said oil to the bearings and/or gears. More generally, the enclosure 426 may be designed to collect oil and guide the oil to the bearings and/or gears.

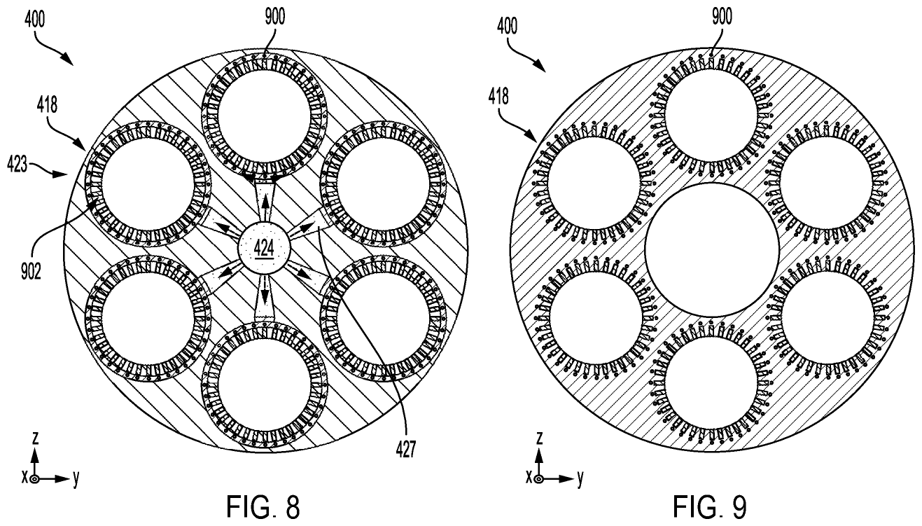

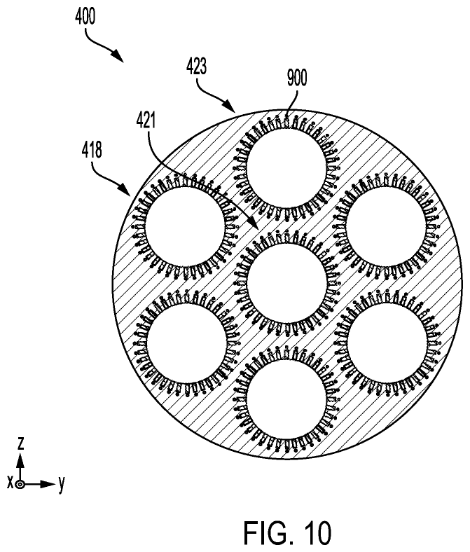

Cutting plane A-A′ denotes the location of the cross-sectional view depicted in FIG. 8, cutting plane B-B′ denotes the location of the cross-sectional view depicted in FIG. 9, and cutting plane C-C′ denotes the location of the cross-sectional view depicted in FIG. 10.

In the electric drive unit 400 depicted in FIG. 4 the pump motor 420 may be conceptually incorporated into the unit as a seventh motor, in one example. The electric drive unit 400 may have a shorter stack length when compared to drive units with a single motor due to the lower power of each motor. This remaining stack length may be used to allow the coolant pump 422 to be space efficiently incorporated into the drive unit.

FIGS. 8-10 illustrate cross-sectional views of the electric drive unit 400 with the stator assembly 417 and the cooling system 418. To elaborate, the pump outlet 424 and the radial cooling channels 427 are depicted. The radial cooling channels are in fluidic communication (e.g., direct fluidic communication) with axial cooling channels 900 which are adjacent to the end windings in the different sets of end windings 423. In this way, the end windings are able to be effectively cooled, thereby increasing drive unit efficiency.

Further, as illustrated in FIGS. 8-10, the stator assembly 417 includes the sets of end windings 423 which include a plurality of end windings 902 which are associated with each rotor in the drive unit. In the illustrated example, the drive unit includes six rotors and associated end windings and a seventh set of end windings (shown in FIG. 10) and rotor for the pump motor in the cooling system. To elaborate, the stator windings 421 of the pump motor are depicted in FIG. 10. However, other drive unit architectures with a greater or fewer number of motors have been contemplated.

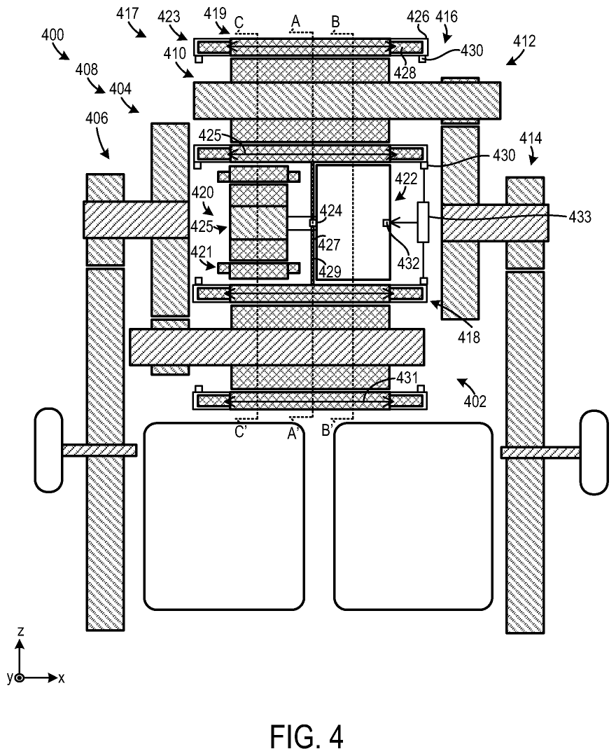

FIGS. 5A and 5B show detailed side views (in relation to the x-axis) with the planetary gear reductions and final gear reductions omitted to reveal underlying components. Specifically, FIG. 5A shows a detailed side view of the electric drive unit 400 and in particular the first set of electric motors 402, the second set of electric motors 410, and pump motor 420. As shown, the first and second sets of electric motors 402 and 410 are again arranged in a circle 500 in the illustrated example, to increase drive unit space efficiency. The pump motor 420 is positioned radially inward from the motors to further increase drive unit space efficiency.

FIG. 5B another detailed side view of the first set of electric motors 402, the second set of electric motors 410, and the coolant pump 422. The first and second sets of electric motors 402 and 410 are again depicted with a circular arrangement and the coolant pump 422 is positioned radially inward from the motors to further increase drive unit compactness.

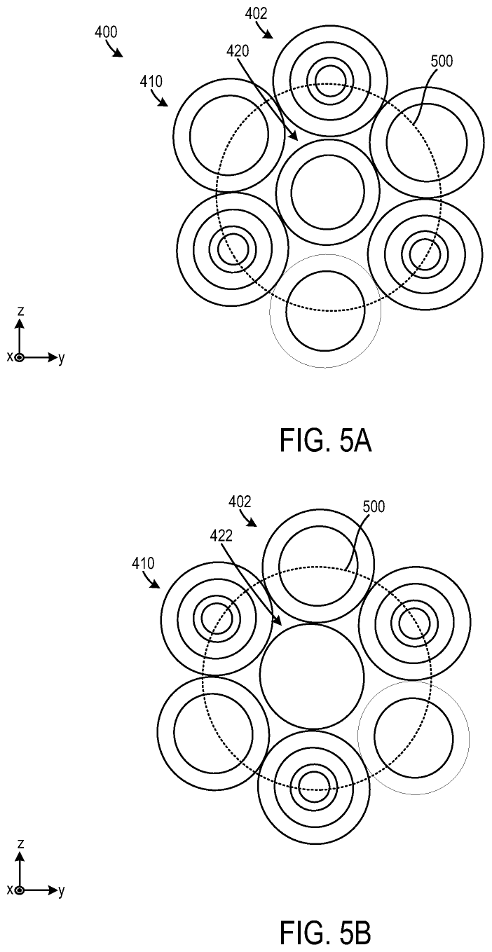

FIG. 6 shows a method 700 for operation of an electric drive unit. The method 700 may be implemented by the electric drive unit 300 shown in FIG. 3 or in another suitable electric drive unit which includes disconnect clutches which are configured to disconnect a portion of the motors in the left and right electric drives during selected operating conditions such as partial load conditions.

At 702, the control method includes determining operating conditions. The operating conditions may include electric drive unit load, electric motor speeds, drive wheel speed, accelerator pedal positon, battery state of charge, and the like. These operating conditions may be ascertained via sensor inputs, modelling, combinations thereof, and the like.

At 704, the method includes determining the electric drive unit is operating under a partial load condition. This determination may compare a measured or calculated drive unit load which may be determined via load sensors at one or more of the electric motors and/or other inputs such as inverter power output, wheel speed, and the like.

If it is determined that the electric drive unit is not operating under a partial load condition (NO at 704), the method moves to 706 where the method includes sustaining engagement of the disconnect clutches in the first electric drive and the second electric drive. For instance, an electro-mechanical, hydraulic, or pneumatic actuator may sustain engagement of the disconnect clutches such that power is transferred through the clutches.

If it is determined that the electric drive unit is operating under a partial load condition (YES at 704), the method moves to 708 where the method includes disengaging a disconnect clutch in each of the first electric drive and the second electric drive. For instance, the clutch actuators may be operated to disengage the disconnect clutches such that power transfer through the clutches is discontinued. Next at 710 the method includes discontinuing power delivery from the inverters to the disconnected electric motors. For instance, switches that enable electrical power transfer to the disconnected motors may be opened to discontinue power delivery from the inverters to the motors. Method 700 allows the electric drive unit's operating efficiency to be increased when the drive unit is operating under partial load conditions.

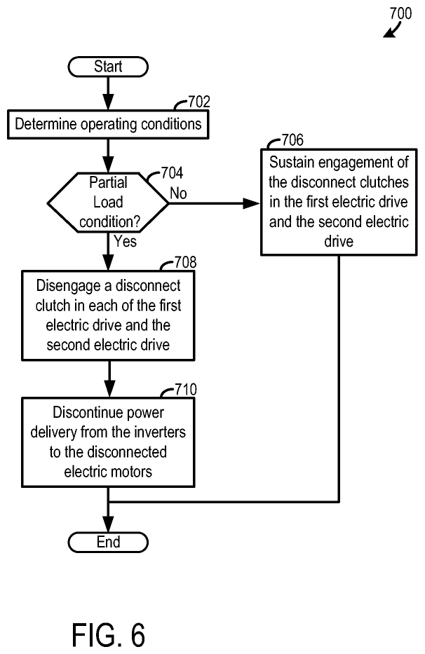

FIG. 7 illustrates a timing diagram 800 of a use-case operating scenario for an electric drive unit. To elaborate, the control strategy embodied in the timing diagram 800 may specifically be implemented by the electric drive unit 300 shown in FIG. 3 or in another suitable electric drive unit which includes disconnect clutches which are configured to disconnect a portion of the motors in the left and right electric drives during selected operating conditions such as partial load conditions. In each graph, time is indicated on the abscissa and increases from left to right. The ordinate for plot 802 indicates electric drive unit load. Although specific values are not provided in the diagram, load increases from bottom to top. The ordinates for plots 804, 806, 808, and 810 indicate the operational states (i.e., “operational” and “shut-down”) of the first electric motor group, the second electric motor group, the third electric motor group, and the fourth electric motor group, respectively. To elaborate, when the electric drive unit 300 shown in FIG. 3 implements the control strategy depicted in FIG. 7, the first electric motor group corresponds to the group of motors 330 which are coupled to planet gears 324, the second electric motor group corresponds to the group of motors 332 which are coupled to the planet gears 326, the third electric motor group corresponds to the group of motors 338 which are coupled to the planet gears 340, and the fourth electric motor group corresponds to the group of motors 346 which are coupled to the planet gears 348.

Continuing with FIG. 7, at to all of the groups of motors are operational. Next at t1, electric drive unit load drops below a threshold value 850 which is indicative of a partial load condition. Responsive to the drive unit load dropping below the threshold value, the first electric motor group and the third electric motor group are shut-down. Shutting down the electric motor groups includes disengaging the disconnect clutches associated with the motor groups and discontinuing the transfer of electrical power to the motor groups from the inverter. Discontinuing electric power transfer may include operating inverter switches that correspond to the second and fourth electric motor groups. Further, in one example, when the electric drive unit includes one inverter which powers all of the motors, synchronizers in each of the left and right electric drives may be engaged, as previously indicated.

The gear sizes and the motor sizes are drawn approximately to scale in FIGS. 1-5B and the electric drive unit in FIGS. 8-10 is drawn approximately to scale. However, the components may have other relative dimensions, in alternate embodiments.

FIGS. 1-5B and 8-11 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such.

The invention is further described in the following paragraphs. In one aspect, an electric drive unit is provided that comprises: a stator assembly including a first set of stator windings and a second set of stator windings; a first set of rotors each configured to: electromagnetically interact with the first set of stator windings; and rotationally coupled to a distinct gear in a first summation gear set; a second set of rotors configured to: electromagnetically interact with the second set of stator windings; and rotationally coupled to a distinct gear in a second summation gear set; and a first inverter and a second inverter electrically coupled to the first set of stator windings and the second set of stator windings, respectively; wherein the first inverter and the second inverter are configured to independently control speeds of the first set of rotors and the second set of rotors, respectively. In one example, rotational axes of the first and second sets of rotors may be arranged in parallel. In another example, the first and second sets of rotors may be positioned between the first and second drive wheels in relation to axes of rotation of the first and second drive wheels which are coaxially arranged with regard to one another. Further, in one example, the distinct gears in the first and second summation gear sets may be a first set of planet gears and a second set of planet gears, respectively, and wherein the first and second sets of planet gears may be the only planet gears in the first and second summation gear sets, respectively. Even further in one example, each of the motors in the first and second set of motors are higher speed motors configured to operate a speeds greater than 25,000 revolutions per minute (RPM). In one example, the electric drive unit may further comprise a first resolver positioned on a first layshaft in the first summation gear set and a second resolver positioned on a second layshaft in the second summation gear set, wherein the first resolver and the second resolver generate data indicative of a speed of the first set of rotors and a speed of the second set of rotors, respectively. In yet another example, the electric drive unit may further comprise a cooling system configured to direct coolant through a first set of lamination stacks, a second set of lamination stacks, end windings associated with the first set of lamination stacks, and end windings that are associated with the second set of lamination stacks which are included in the stator assembly. In another example, the electric drive unit may further comprise a pump motor rotationally coupled to a coolant pump, wherein the pump motor and the coolant pump are incorporated into the first set of laminations stacks and the second set of lamination stacks. Further, in one example, the coolant may be oil. In one example, the first set of lamination stacks and the second set of lamination stacks may be separated by an oil distribution plate. In another example, a baffle may be used to distribute the coolant to the stator assembly. In another example, the first summation gear set may be rotationally coupled to a first drive wheel via a first final gear reduction; and the second summation gear set may be rotationally coupled to a second drive wheel via a second final gear reduction.

In another aspect, a method for operation of an electric axle is provided that comprises operating a first inverter to cause mechanical power transfer from a first set of rotors to a first summation gear set; and operating a second inverter to cause mechanical power transfer from a second set of rotors to a second summation gear set; wherein each of the rotors in the first and second sets of rotors are configured to electromagnetically interact with a stator assembly that includes a first set of stator windings and a second set of stator windings that circumferentially surround the first set of rotors and the second set of rotors, respectively; wherein the first summation gear set is rotationally coupled to a first drive wheel; and wherein the second summation gear set is rotationally coupled to a second drive wheel. In one example, the first inverter and the second inverter may be independently operated. In yet another example, the first inverter may be operated based on data generated by a first resolver that positioned on a first layshaft in the first summation gear set; and the second inverter may be operated based on data generated by a second resolver that is positioned on a second layshaft in the second summation gear set. The method may further comprise, in one example, operating a pump motor that is rotationally coupled to a coolant pump to drive coolant flow in a cooling system configured to circulate coolant through the stator assembly.

In another aspect, an electric axle is provided that comprises a stator assembly include a first set of stator laminations and a second set of stator laminations; a first set of rotors configured to electromagnetically interact with the first set of stator laminations; and a second set of rotors configured to electromagnetically interact with the second set of stator laminations; a first inverter electrically coupled to the first set of stator laminations in parallel; and a second inverter electrically coupled to the second set of stator laminations in parallel; wherein rotational axes of the first and second sets of rotors are circumferentially arranged in parallel. In one example, the electric axle may further comprise an oil cooling system configured to direct oil through a first set of lamination stacks, a second set of lamination stacks, end windings associated with the first set of lamination stacks, and end windings that are associated with the second set of lamination stacks which are included in the stator assembly. In another example, the electric axle may further comprise a pump motor rotationally coupled to an oil pump, wherein the pump motor and the oil pump are positioned circumferentially inward from the first and second sets of electric motors which are circumferentially arranged. Further in one example, the first summation gear set may include a sun gear that is rotationally coupled to a first drive wheel via a first final gear reduction; and the second summation gear set may include a sun gear that is rotationally coupled to a second drive wheel via a second final gear reduction. In another example, the first and second summation gear sets are simple summation gear sets.

In another aspect, an electric drive unit is provided that comprises a stator assembly including a first set of stator windings and a second set of stator windings; a first set of rotors in which each rotor is configured to: electromagnetically interact with the first set of stator windings; and rotationally coupled to a distinct gear in a first summation gear set; a second set of rotors in which each rotor is configured to: electromagnetically interact with the second set of stator windings; and rotationally coupled to a distinct gear in a second summation gear set; a first disconnect clutch configured to rotationally disconnect a first rotor in the first set of rotors from the first summation gear set; and a second disconnect clutch configured to rotationally disconnect a first rotor in the second set of rotors from the second summation gear set. In one example, the first and second summation gear sets may be compound summation gear sets. In yet another example, the compound summation gear sets may be stepped summation gear sets. Further, in one example, the electric drive unit may further comprise a controller including instructions stored in memory that when executed cause the controller to: during a partial load condition, disengage the first disconnect clutch and the second disconnect clutch. In another example, rotational axes of the first set of rotors and the second set of rotors may be circumferentially arranged. In another example, the electric drive unit may further comprise a first synchronizer configured to selectively lock the rotational position of the first rotor in the first set of rotors when the first disconnect clutch is disengaged; and a second synchronizer configured to selectively lock the rotational position of the first rotor in the second set of rotors when the second disconnect clutch is disengaged. In another example, the electric drive unit may further comprise a cooling system configured to direct coolant through a first set of lamination stacks, a second set of lamination stacks, end windings associated with the first set of lamination stacks, and end windings that are associated with the second set of lamination stacks which are included in the stator assembly. In another example, the electric drive unit may further comprise a first inverter and a second inverter each of which are electrically coupled to the stator assembly. In another example, the first inverter may include switches configured to independently electrically disconnect a lamination stack corresponding to the first rotor in the first set of rotors; and the second inverter may include switches configured to independently electrically disconnect a lamination stack corresponding to the first rotor in the second set of rotors. Further, in one example, the first summation gear set and the second summation gear set may each have a V-type arrangement.

In another aspect, a method for operation of an electric drive unit is provided that comprises operating a first disconnect clutch to selectively rotationally disconnect one rotor in a first set of rotors from a first summation gear set; and operating a second disconnect clutch to selectively rotationally disconnect one rotor in a second set of rotors from a second summation gear set; wherein the electric drive unit includes: a stator assembly; the first set of rotors each configured to: electromagnetically interact with the stator assembly; and rotationally coupled to a distinct gear in a first summation gear set; and the second set of rotors configured to: electromagnetically interact with the stator assembly; and rotationally coupled to a distinct gear in a second summation gear set. In one example, the method may further comprise operating a first inverter to discontinue mechanical power transfer from the one rotor in the first set of rotors to the first summation gear set; and operating a second inverter to discontinue mechanical power transfer from the one rotor in the second set of rotors to the second summation gear set. In another example, the method may further comprise operating a first synchronizer to lock a rotational position of the one rotor in the first set of rotors in relation to the other rotors in the first set of rotors when the first disconnect clutch is disengaged; and operating a second synchronizer to lock a rotational position of one rotor in the second set of rotors in relation to the other rotors in the second set of rotors when the second disconnect clutch is disengaged. In another example, operating the first inverter may include operating a first set of switches associated with stator windings that electromagnetically interact with the inactive rotor in the first set of rotors and operating the second inverter may include operating a second set of switches associated with stator windings that electromagnetically interact with the inactive rotor in the second set of rotors. In another example, the method may further comprise providing electrical energy to a first set of stator windings and a second set of stator windings from the first inverter and the second inverter, respectively, wherein the first set of laminations stacks corresponds to active rotors in the first set of rotors and the second set of stator windings correspond to active rotors in the second set of rotors.

In yet another aspect, an electric axle is provided that comprises a first set of rotors where each rotor is configured to: electromagnetically interact with a first set of stator windings; and rotationally coupled to a planet gear in a first summation gear set; a second set of rotors where each rotor is configured to: electromagnetically interact with a second set of stator windings; and rotationally coupled to a distinct gear in a second summation gear set; a first disconnect clutch configured to rotationally disconnect a first rotor in the first set of rotors from the first summation gear set; and a second disconnect clutch configured to rotationally disconnect a first rotor in the second set of rotors from the second summation gear set. In another example, the electric axle may further comprise a first inverter that includes switches configured to independently electrically disconnect a stator winding in the first set of stator windings; and a second inverter that includes switches configured to independently electrically disconnect a stator winding in the second set of stator windings. In another example, the electric axle may further comprise a first synchronizer configured to selectively lock the rotational position of the first rotor in the first set of rotors when the first disconnect clutch is disengaged; and a second synchronizer configured to selectively lock the rotational position of the first rotor in the second set of rotors when the second disconnect clutch is disengaged. Further, in one example, the first disconnect clutch may be configured to disconnect a first sun gear in the first summation gear set and the second disconnect clutch is configured to disconnect a second sun gear in the second summation gear set. In another example, the first summation gear set may include a third sun gear and the second summation gear set includes a fourth sun gear.

The control methods and routines disclosed herein may be stored as executable instructions in non-transitory memory and may be carried out by an electric drive unit and/or system that includes the controller in combination with the various sensors and actuators. Further, portions of the methods may be physical actions taken in the real world to change a state of a device. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the examples described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the system, where the described actions are carried out by executing the instructions in a system including the various hardware components in combination with the electronic controller. One or more of the method steps described herein may be omitted if desired.

While various embodiments have been described above, it should be understood that they have been presented by way of example, and not limitation nor restriction. It will be appreciated that the configurations and routines disclosed herein are exemplary in nature, and that these specific examples are not to be considered in a limiting sense, because numerous variations are possible. For example, the above technology can be applied to powertrains that include different types of propulsion sources including different types of electric machines, internal combustion engines, and/or transmissions. The technology may be used as a stand-alone, or used in combination with other power transmission systems not limited to machinery and propulsion systems for different types of electric axles, HEVs, BEVs, agriculture, marine, motorcycle, recreational vehicles, and on and off highway vehicles, as an example. The subject matter of the present disclosure includes all novel and non-obvious combinations and sub-combinations of the various systems and configurations, and other features, functions, and/or properties disclosed herein. It will be apparent to persons skilled in the relevant arts that the disclosed subject matter may be embodied in other specific forms without departing from the spirit of the subject matter.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

As used herein, the term “approximately” is construed to mean plus or minus one percent of the range, unless otherwise specified.

1. An electric drive unit, comprising:
a stator assembly including a first set of stator windings and a second set of stator windings;
a first set of rotors in which each rotor is configured to:
electromagnetically interact with the first set of stator windings; and
rotationally couple to a distinct gear in a first summation gear set;
a second set of rotors in which each rotor is configured to:
electromagnetically interact with the second set of stator windings; and
rotationally couple to a distinct gear in a second summation gear set;
a first disconnect clutch configured to rotationally disconnect a first rotor in the first set of rotors from the first summation gear set; and
a second disconnect clutch configured to rotationally disconnect a first rotor in the second set of rotors from the second summation gear set.

2. The electric drive unit of claim 1, wherein the first and second summation gear sets are compound summation gear sets.

3. The electric drive unit of claim 2, wherein the compound summation gear sets are stepped summation gear sets.

4. The electric drive unit of claim 1, further comprising a controller including instructions stored in memory that when executed cause the controller to:
during a partial load condition, disengage the first disconnect clutch and the second disconnect clutch.

5. The electric drive unit of claim 1, wherein rotational axes of the first set of rotors and the second set of rotors are circumferentially arranged.

6. The electric drive unit of claim 1, further comprising:
a first synchronizer configured to selectively lock a rotational position of the first rotor in the first set of rotors when the first disconnect clutch is disengaged; and
a second synchronizer configured to selectively lock a rotational position of the first rotor in the second set of rotors when the second disconnect clutch is disengaged.

7. The electric drive unit of claim 1, further comprising a cooling system configured to direct coolant through a first set of lamination stacks, a second set of lamination stacks, end windings associated with the first set of lamination stacks, and end windings that are associated with the second set of lamination stacks which are included in the stator assembly.

8. The electric drive unit of claim 1, further comprising:
a first inverter and a second inverter each of which are electrically coupled to the first set of stator windings and the second set of stator windings, respectively.

9. The electric drive unit of claim 8, wherein:
the first inverter includes switches configured to independently electrically disconnect the first set of stator windings; and
the second inverter includes switches configured to independently electrically disconnect the second set of stator windings.

10. The electric drive unit of claim 1, wherein the first summation gear set and the second summation gear set each have a V-type arrangement.

11. A method for operation of an electric drive unit, comprising:
operating a first disconnect clutch to selectively rotationally disconnect one rotor in a first set of rotors from a first summation gear set; and
operating a second disconnect clutch to selectively rotationally disconnect one rotor in a second set of rotors from a second summation gear set;
wherein the electric drive unit includes:
a stator assembly with a first set of stator windings and a second set of stator windings;
the first set of rotors each configured to:
electromagnetically interact with the first set of stator windings; and
rotationally coupled to a distinct gear in the first summation gear set; and
the second set of rotors configured to:
electromagnetically interact with the second set of stator windings; and
rotationally couple to a distinct gear in the second summation gear set.

12. The method of claim 11, further comprising:
operating a first inverter to discontinue mechanical power transfer from the one rotor in the first set of rotors to the first summation gear set; and
operating a second inverter to discontinue mechanical power transfer from the one rotor in the second set of rotors to the second summation gear set.

13. The method of claim 12, further comprising:
operating a first synchronizer to lock a rotational position of the one rotor in the first set of rotors in relation to the other rotors in the first set of rotors when the first disconnect clutch is disengaged; and
operating a second synchronizer to lock a rotational position of one rotor in the second set of rotors in relation to the other rotors in the second set of rotors when the second disconnect clutch is disengaged.

14. The method of claim 12, wherein operating the first inverter includes operating a first set of switches associated with the first set of stator windings that electromagnetically interact with the inactive rotor in the first set of rotors and operating the second inverter includes operating the second set of stator windings that electromagnetically interact with the inactive rotor in the second set of rotors.

15. The method of claim 12, further comprising providing electrical energy to the first set of stator windings and the second set of stator windings from the first inverter and the second inverter, respectively, wherein the set of stator windings corresponds to active rotors in the first set of rotors and the second set of stator windings corresponds to active rotors in the second set of rotors.

16. An electric axle comprising:
a first set of rotors where each rotor is configured to:
electromagnetically interact with a first set of stator windings; and
rotationally couple to a planet gear in a first summation gear set;
a second set of rotors where each rotor is configured to:
electromagnetically interact with a second set of stator windings; and
rotationally couple to a distinct gear in a second summation gear set;
a first disconnect clutch configured to rotationally disconnect a first rotor in the first set of rotors from the first summation gear set; and
a second disconnect clutch configured to rotationally disconnect a first rotor in the second set of rotors from the second summation gear set.

17. The electric axle of claim 16, further comprising:
a first inverter that includes switches configured to independently electrically disconnect a stator winding in the first set of stator windings; and
a second inverter that includes switches configured to independently electrically disconnect a stator winding in the second set of stator windings.

18. The electric axle of claim 17, further comprising:
a first synchronizer configured to selectively lock a rotational position of the first rotor in the first set of rotors when the first disconnect clutch is disengaged; and
a second synchronizer configured to selectively lock a rotational position of the first rotor in the second set of rotors when the second disconnect clutch is disengaged.

19. The electric axle of claim 16, wherein the first disconnect clutch is configured to disconnect a first sun gear in the first summation gear set and the second disconnect clutch is configured to disconnect a second sun gear in the second summation gear set.

20. The electric axle of claim 19, wherein the first summation gear set includes a third sun gear and the second summation gear set includes a fourth sun gear.
